(19) United States
(12) Patent Application Publication
(10) Pub. No.: US 2026/0105925 A1
(43) Pub. Date: Apr. 16, 2026

(54) AUDIO DECODER, AUDIO ENCODER AND METHOD FOR CODING OF FRAMES USING A QUANTIZATION NOISE SHAPING

(71) Applicant: Fraunhofer-Gesellschaft zur Förderung der angewandten Forschung e.V., München (DE)

(72) Inventors: Christian HELMRICH, Berlin (DE); Guillaume FUCHS, Erlangen (DE); Goran MARKOVIC, Erlangen (DE); Matthias NEUSINGER, Erlangen (DE); Richard FÜG, Erlangen (DE); Manfred LUTZKY, Erlangen (DE)

(73) Assignee: Fraunhofer-Gesellschaft zur Förderung der angewandten Forschung e.V., München (DE)

(21) Appl. No.: 19/420,727

(22) Filed: Dec. 15, 2025

Related U.S. Application Data
(63) Continuation of application No. PCT/EP2024/066255, filed on Jun. 12, 2024.

(30) Foreign Application Priority Data
Jun. 16, 2023 (EP) 23179891.9

(51) Int. Cl. G10L 19/08; G10L 19/26

(52) U.S. Cl. CPC G10L 19/08; G10L 19/26

(57) ABSTRACT

Embodiments comprise an audio decoder configured to, for a predetermined frame among consecutive frames, decode, from a data stream, a quantized spectrum and a linear prediction coefficient based envelope representation; to locate, in the quantized spectrum, zero-quantized portions and non-zero-quantized portions and to derive a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation; and to reconstruct the predetermined frame using the dequantized spectrum; so that, for a predetermined portion, the modification according to the first and the second manner cause a spectral quantization noise shaping which comprises different smoothness characteristics.

Corresponding encoders and methods are also disclosed.

This application is a continuation of copending International Application No. PCT/EP2024/066255, filed Jun. 12, 2024, which is incorporated herein by reference in its entirety, and additionally claims priority from European Application No. EP 23179891.9, filed Jun. 16, 2023, which is also incorporated herein by reference in its entirety.

Embodiments according to the invention are related to audio coding and especially to noise shaping in connection with audio coding.

Embodiments are related to audio decoders, audio encoders and methods for coding of frames using a quantization noise shaping, for example, with adapted smoothness.

Embodiments are related to an efficient separation of signal envelopes and masking envelopes in low-rate audio coding.

### BACKGROUND OF THE INVENTION

Low-bitrate audio coding, applying time-frequency transformation, e.g., via the MDCT to the waveform segments associated with individual frames f and subsequent quantization of the resulting spectra S_{f} to reach strong compression, greatly benefits from parametric coding tools such as noise filling (NF), spectral band replication (SBR), and intelligent gap filling (IGF).

Such parametric coding tools are used to improve acoustic properties of, and thus promote the occurrence of, zero quantized portions of a respective audio signal. Accordingly, different portions of a respective audio signal are coded using different coding tools. In particular, some spectral portions of an audio signal may be subject to parametric coding tools and others to non-parametric coding tools. However, according to conventional approaches, the combination of such different coding approaches may yield, at least in some cases, insufficient results, for example with regard to an acoustic quality of a reconstructed, decoded version of the audio signal.

Therefore, it is the object of the present invention to provide a concept for a coding of an audio signal that achieves an improved compromise between a strong compression and a good acoustic quality.

This is achieved by the subject matter of the independent claims of the present application. Further embodiments according to the invention are defined by the subject matter of the dependent claims of the present application.

### SUMMARY

An embodiment may have an audio decoder configured to, for a predetermined frame among consecutive frames, decode, from a data stream, a quantized spectrum; a linear prediction coefficient based envelope representation, locate, in the quantized spectrum, one or more zero-quantized portions and one or more non-zero-quantized portions, derive a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation, reconstruct the predetermined frame using the dequantized spectrum, wherein the audio decoder is configured so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

Another embodiment may have an audio decoder configured to, for a predetermined frame among consecutive frames, decode, from a data stream, a quantized spectrum; a linear prediction coefficient based spectral envelope representation, locate, in the quantized spectrum, one or more zero-quantized portions and one or more non-zero-quantized portions, derive a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation, reconstruct the predetermined frame using the dequantized spectrum, wherein the audio decoder is configured so that the first spectral shaping function is different from, e.g. less smooth than, the second spectral shaping function.

Another embodiment may have an audio decoder configured to, for a predetermined frame among consecutive frames, decode, from a data stream, a quantized spectrum; a linear prediction coefficient based temporal envelope representation, locate, in the quantized spectrum, one or more zero-quantized portions and one or more non-zero-quantized portions, derive a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation, reconstruct the predetermined frame using the dequantized spectrum, wherein the audio decoder is configured so that a transfer function of the first filter is different from, e.g. less smooth than, a transfer function of the second filter.

Another embodiment may have an audio encoder configured to, for a predetermined frame among consecutive frames, encode, into a data stream, a quantized spectrum; a linear prediction coefficient based envelope representation, locate, in the quantized spectrum, zero-quantized portions and non-zero-quantized portions, derive a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation, use the dequantized spectrum for encoding further frames, wherein the audio encoder is configured so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

Another embodiment may have an audio encoder configured to, for a predetermined frame among consecutive frames, encode, into a data stream, a quantized spectrum; a linear prediction coefficient based spectral envelope representation, locate, in the quantized spectrum, zero-quantized portions and non-zero-quantized portions, derive a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation, use the dequantized spectrum for encoding further frames, wherein the audio encoder is configured so that the first spectral shaping function is less smooth than the second spectral shaping function.

Another embodiment may have an audio encoder configured to, for a predetermined frame among consecutive frames, encode, into a data stream, a quantized spectrum; a linear prediction coefficient based temporal envelope representation, locate, in the quantized spectrum, zero-quantized portions and non-zero-quantized portions, derive a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation, use the dequantized spectrum for encoding further frames, wherein the audio encoder is configured so that a transfer function of the first filter is less smooth than a transfer function of the second filter.

According to another embodiment, a method for a predetermined frame among consecutive frames may have the steps of: decoding, from a data stream, a quantized spectrum, and a linear prediction coefficient based envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation, reconstructing the predetermined frame using the dequantized spectrum, wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a 25 spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

According to another embodiment, a method for a predetermined frame among consecutive frames may have the steps of: decoding, from a data stream, a quantized spectrum, a linear prediction coefficient based spectral envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation; reconstructing the predetermined frame using the dequantized spectrum; wherein the first spectral shaping function is different from, e.g. less smooth than, the second spectral shaping function.

According to another embodiment, a method for a predetermined frame among consecutive frames may have the steps of: decoding, from a data stream, a quantized spectrum and a linear prediction coefficient based temporal envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation; reconstructing the predetermined frame using the dequantized spectrum; wherein a transfer function of the first filter different from, e.g. is less smooth than, a transfer function of the second filter.

According to another embodiment, a method for a predetermined frame among consecutive frames may have the steps of: encoding, into a data stream, a quantized spectrum and a linear prediction coefficient based envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum modifying the quantized spectrum depending, in a second manner, on the linear prediction coefficient based envelope representation; using the dequantized spectrum for encoding further frames, wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

According to another embodiment, a method for a predetermined frame among consecutive frames may have the steps of: encoding, into a data stream, a quantized spectrum, and a linear prediction coefficient based spectral envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation; using the dequantized spectrum for encoding further frames; wherein the first spectral shaping function is different from, e.g. less smooth than, the second spectral shaping function.

According to another embodiment, a method for a predetermined frame among consecutive frames may have the steps of: encoding, into a data stream, a quantized spectrum and a linear prediction coefficient based temporal envelope representation; locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation; using the dequantized spectrum for encoding further frames; wherein a transfer function of the first filter is different from, e.g. less smooth than, a transfer function of the second filter.

Another embodiment may have a non-transitory digital storage medium having a computer program stored thereon to perform any of the inventive methods when said computer program is run by a computer.

Embodiments according to the invention comprise an audio decoder configured to, for a predetermined frame among consecutive frames, decode, from a data stream (e.g. bitstream), a quantized spectrum and a linear prediction coefficient based envelope representation.

Furthermore, the decoder is configured to locate, in the quantized spectrum, one or more zero-quantized portions and one or more non-zero-quantized portions and to derive a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation.

In addition, the decoder is configured to reconstruct the predetermined frame using the dequantized spectrum. The audio decoder is configured so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different, for example less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, for example less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

The inventors recognized that, despite the transmission of a linear prediction coefficient, LPC, based envelope representation which relates to both zero-quantized and non-zero-quantized portions, a different sort of shaping should be applied to zero-quantized portions on the one hand and portions which are not quantized to zero on the other hand. For portions that are not quantized to zero, a perceptual masking envelope, for example as defined by a transfer function, e.g. LPC_{f}, of a linear prediction filter, should form the basis for noise shaping in order to attain waveform preservation. In contrast, for a reconstruction of zero-quantized portions, an approximation of the original signal energy suffices in order to shape synthesized spectral data.

Accordingly, the inventors recognized that using the same envelope for the two diverging requirements may yield unfavorable results. Hence, the inventors recognized that different shaping approaches for the case of a predetermined portion being a zero-quantized portion and the case of a predetermined portion being a non-zero-quantized portion may be advantageous.

In this regard, the inventors recognized that the shaping should be different for zero-quantized portions than for non-zero-quantized portions. For instance, the shaping should be less smooth for the zero-quantized portions.

Beyond that, the inventors recognized that this difference, such as the difference in smoothness, may be advantageously applied in spectral quantization noise shaping and/or for temporal quantization noise shaping. In other words, embodiments allow to account for differences between perceptual masking envelopes and signal envelopes in temporal direction and/or in frequency direction.

Accordingly, with regard to a spectral smoothness adaptation, as an optional feature, the linear prediction coefficient based envelope representation may comprise a linear prediction coefficient based spectral envelope representation, and the modification of the quantized spectrum which is used in case of the predetermined portion being a zero-quantized portion, and depends on the linear prediction coefficient based envelope representation, may involve a spectral shaping. Here, the modification may be performed such that a first spectral shaping function which depends, according to a first manner, on the linear prediction coefficient based spectral envelope representation, and which is involved by the modification in case of the predetermined portion being a zero-quantized portion, is different from a second spectral shaping function which is involved by the modification in case of predetermined portion being a non-zero-quantized portion, and depends, according to the second manner, on the linear prediction coefficient based envelope representation. For example, the first spectral shaping function may be less smooth than the second spectral shaping function such as being less dynamic or being less spread in terms of the function's range, i.e. having a smaller range. As an example, optionally an energy of the function may be distributed over a smaller range.

Alternatively or in addition, with regard to a temporal smoothness adaptation, the linear prediction coefficient based envelope representation may comprise a linear prediction coefficient based temporal envelope representation. The modification which is used in case of predetermined portion being a zero-quantized portion, and depends, according to the first manner, on the linear prediction coefficient based envelope representation optionally involves a filtering using a first filter which depends on the linear prediction coefficient based temporal envelope representation, and the modification which is used in case of predetermined portion being a non-zero-quantized portion, and depends, according to the second manner, on the linear prediction coefficient based envelope representation may involve a filtering using a second filter which depends on the linear prediction coefficient based temporal envelope representation and is different from the first filter. For example, first and second filter may differ in that a transfer function of the first filter is less smooth than a transfer function of the second filter.

Accordingly, in other words and as an example, embodiments may allow to perform different scalings of portions of a spectrum that are quantized to zero in contrast to portions of the spectrum that are not quantized to zero. In time and/or frequency, different envelopes (e.g. perceptual masking envelope vs. signal envelope) of a respective spectrum or acoustic signal for zero-quantized and non-zero quantized portions may hence be used. As explained above, usage of filter coefficients, e.g. defining a spectral shaping function and/or a transfer function which lead to a less smooth scaling of the zero quantized and synthesized filled portions in contrast to the non-zero quantized portions allow to reconstruct an audio frame with improved acoustic characteristics.

With regard to respective envelopes and hence filter coefficients or respective scaling factors, the smoothness referred to above with respect to certain functions or some shaping may describe the function's spectral spread of its spectrum, a width of the function's range or that the shaping follows curve functions having these characteristics, respectively. As an example, a bandwidth expansion of an LPC filter defined by the linear prediction coefficient based envelope representation may be used to as a means to lead to an increased smoothness of the LPC filter's transfer function compared to a version not expanded, and the transfer function may represent spectral envelope or temporal envelope, respectively.

Further embodiments comprise an audio encoder configured to, for a predetermined frame among consecutive frames, encode, into a data stream, a quantized spectrum and a linear prediction coefficient based envelope representation. Furthermore, the encoder is configured to locate, in the quantized spectrum, zero-quantized portions and non-zero-quantized portions, derive a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation and to use the dequantized spectrum for encoding further frames,

In addition, the audio encoder is configured so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different, for example less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, for example less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

The encoder as described above is based on the same considerations as the above-described decoder. The encoder can, by the way, be completed with all features and functionalities, which are also described with regard to the decoder and vice versa.

Further embodiments comprise a method, for a predetermined frame among consecutive frames, wherein the method comprises decoding, from a data stream, a quantized spectrum, and a linear prediction coefficient based envelope representation. Furthermore, the method comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum, modifying the quantized spectrum depending, in a second manner, on the linear prediction coefficient based envelope representation,

Furthermore, the method comprises reconstructing the predetermined frame using the dequantized spectrum, wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

Embodiments comprise a method 1000, for a predetermined frame among consecutive frames, wherein the method comprises decoding, from a data stream, a quantized spectrum, a linear prediction coefficient based spectral envelope representation. The method further comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation. Furthermore, the method comprises reconstructing the predetermined frame using the dequantized spectrum. In addition, the first spectral shaping function is different from, e.g. less smooth than, the second spectral shaping function.

Embodiments comprise a method, for a predetermined frame among consecutive frames, wherein the method comprises decoding, from a data stream, a quantized spectrum and a linear prediction coefficient based temporal envelope representation. Furthermore, the method comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation. In addition, the method comprises reconstructing the predetermined frame using the dequantized spectrum. Thereby, a transfer function of the first filter different from, e.g. is less smooth than, a transfer function of the second filter.

Further embodiments comprise a method for a predetermined frame among consecutive frames, wherein the method comprises encoding, into a data stream, a quantized spectrum and a linear prediction coefficient based envelope representation. Furthermore, the method comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data modified depending, according to a first manner, on the linear prediction coefficient based envelope representation, and in non-zero-quantized portions of the quantized spectrum modifying the quantized spectrum depending, in a second manner, on the linear prediction coefficient based envelope representation.

Furthermore, the method comprises using the dequantized spectrum for encoding further frames, wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

Embodiments comprise a method, for a predetermined frame among consecutive frames, wherein the method comprises encoding, into a data stream, a quantized spectrum, and a linear prediction coefficient based spectral envelope representation. Furthermore, the method comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation. In addition, the method comprises using the dequantized spectrum for encoding further frames. Thereby, the first spectral shaping function is different from, e.g. less smooth than, the second spectral shaping function.

Embodiments comprise a method, for a predetermined frame among consecutive frames, wherein the method comprises encoding, into a data stream, a quantized spectrum and a linear prediction coefficient based temporal envelope representation. The method further comprises locating, in the quantized spectrum, one or more zero-quantized portions and one or more non-zero-quantized portions, deriving a dequantized spectrum using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation. In addition, the method comprises using the dequantized spectrum for encoding further frames. Thereby, a transfer function of the first filter is different from, e.g. less smooth than, a transfer function of the second filter.

The methods as described above are based on the same considerations as the above-described encoders and/or decoders. The methods can, by the way, be completed with all features and functionalities, which are also described with regard to the encoders and/or decoders.

### BRIEF DESCRIPTION OF THE DRAWINGS

Embodiments of the present invention will be detailed subsequently referring to the appended drawings, in which:

FIG. 1 shows an audio decoder according to embodiments of the invention;

FIG. 2 shows an audio encoder according to embodiments of the invention;

FIG. 3 a, b show schematic examples of intensities over time or frequency, according to conventional approaches, FIG. 3 a, and according to embodiments of the invention, FIG. 3 b; and

FIG. 4 shows schematic examples of magnitudes in dB over normalized time (frame duration) according to embodiments.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well-known structures and devices are shown in block diagram form rather than in detail in order to avoid obscuring embodiments of the present invention. In addition, features of the different embodiments described herein after may be combined with each other, unless specifically noted otherwise.

As explained before, low-bitrate audio coding, applying time-frequency transformation, e.g., via the MDCT to the waveform segments associated with individual frames f and subsequent quantization of the resulting spectra S_{f} to reach strong compression, greatly benefits from parametric coding tools such as noise filling (NF), spectral band replication (SBR), and intelligent gap filling (IGF). During the development of recent audio coding standards like EVS and MPEG-H Audio [1, 2], the inventors recognized that the use of a single frame-wise spectral-envelope representation, e.g., a linear predictive coding envelope LPC_{f}, with both the non-parametric spectral-quantization part and parametric NF or bandwidth extension part of the audio codec may cause insufficient audio quality after decoding.

The inventors recognized that a reason for this phenomenon may be that the non-parametric and parametric coding aspects may, for example, operate in different domains—the waveform preserving, quantization related non-parametric part may intend to shape the coding noise introduced by the quantizer according to the spectrotemporal perceptual masking envelope, whereas the NF and bandwidth extension schemes may intend to reconstruct the original signal energy, i.e., the spectrotemporal signal envelope itself, in certain (e.g. higher-frequency) spectral bands. A simple tilt correction of the masking envelope (e.g., LPC_{f}) when used in the decoderside NF methods, as first employed in EVS [1] and further improved towards the IVAS standardization in [3], may, therefore, be insufficient for high-quality low-rate audio coding.

Moreover, the inventors recognized that no attempt is made in the referenced conventional technology to account for differences between masking envelope and signal envelope in temporal direction. More precisely, the temporal noise shaping (TNS) filtering applied in modern 3GPP and MPEG audio coding standards is the same in both non-parametric and parametric spectral regions (the filter's transfer function reflects the masking envelope in both cases), i.e., it does not distinguish between waveform coded and energy coded spectral components and treats all spectral coefficients as if they were quantized to non-zero coefficient values.

Embodiments hence address the need for improved spectrotemporal shaping of coding noise in audio coding especially at low bit-rates. Therefore, embodiments comprise methods and respective apparatuses that
apply corrective spectral shaping to LPC envelope shaped spectra to properly reconstruct the spectral signal envelope in contiguously zero-quantized regions, and/or
apply corrective temporal shaping to TNS synthesis filtered spectra to properly reconstruct the temporal signal envelope in contiguous zero-quantized regions,
where, in one or even both cases, the corrective shaping may, for example, be directly derived from the spectral and/or temporal shaping envelope and may optionally serve to compensate for smoothing in the envelope.

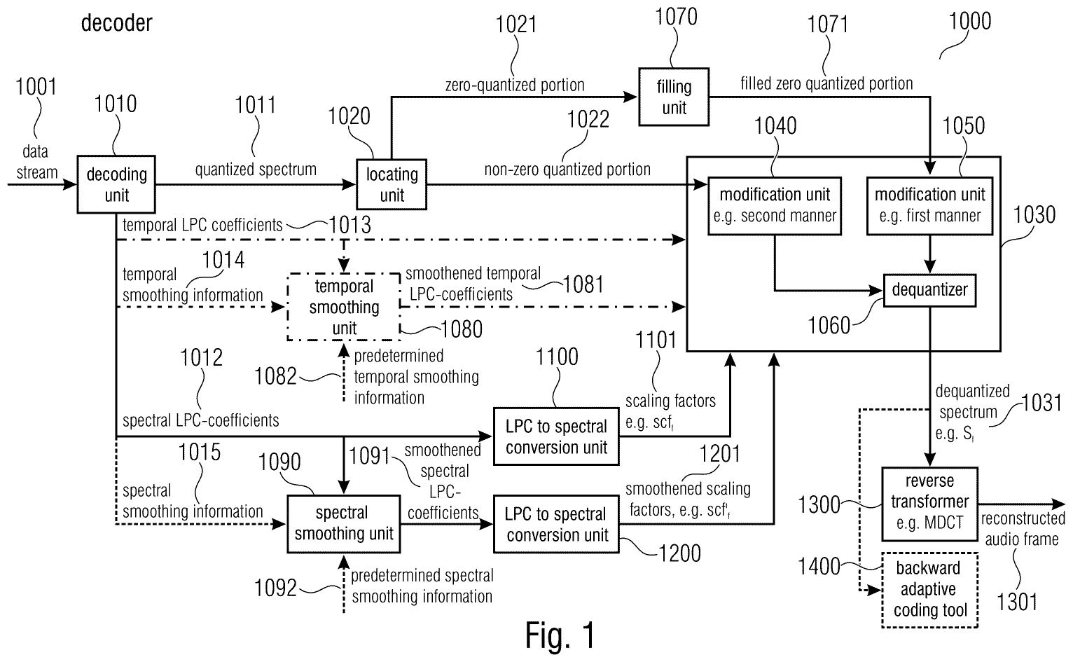

FIG. 1 shows an audio decoder according to embodiments of the invention. FIG. 1 shows an audio decoder 1000, which is configured to receive a data stream 1001, wherein the data stream 1001 comprises a predetermined encoded audio frame among consecutive encoded frames. The decoder 1000 is configured to decode, using a decoding unit 1010, from the data stream 1001, a quantized spectrum 1011, for example representing an acoustic information of the predetermined, encoded audio frame, and to decode a linear prediction coefficient, LPC, based envelope representation. In other words, the decoder receives data stream 1001 into which an audio signal is encoded in temporal units of frames, and the decoding unit 1001 decodes for a predetermined or current audio frame, its quantized spectrum along with the LPC based envelope representation. Note that, as explained later on, the frames might be coded using different coding modes.

Optionally, decoding unit 1010 may be configured to decode, from the data stream 1001, the quantized spectrum 1011 by entropy decoding, such as arithmetic coding, and/or in form of spectral coefficient levels of an MDCT.

As explained before, the LPC based envelope representation may comprise a LPC based spectral envelope representation, i.e. a representation of the spectral envelope of the audio frame or of the envelope of the frame's spectrum, and/or a LPC based temporal envelope representation, i.e. a representation of the temporal envelope of the audio frame or of the envelope of the frame in time domain. As respective examples in FIG. 1, the LPC based spectral envelope representation is decoded from the data stream 1001 in the form of LPC coefficients to yield, as described later on, spectral LPC coefficients 1012 and smoothened spectral LPC coefficients 1091, and the LPC based temporal envelope representation is decoded from the data stream 1001 in the form of LPC coefficients as well, to yield temporal LPC coefficients 1013 and smoothened temporal LPC-coefficients 1081, respectively.

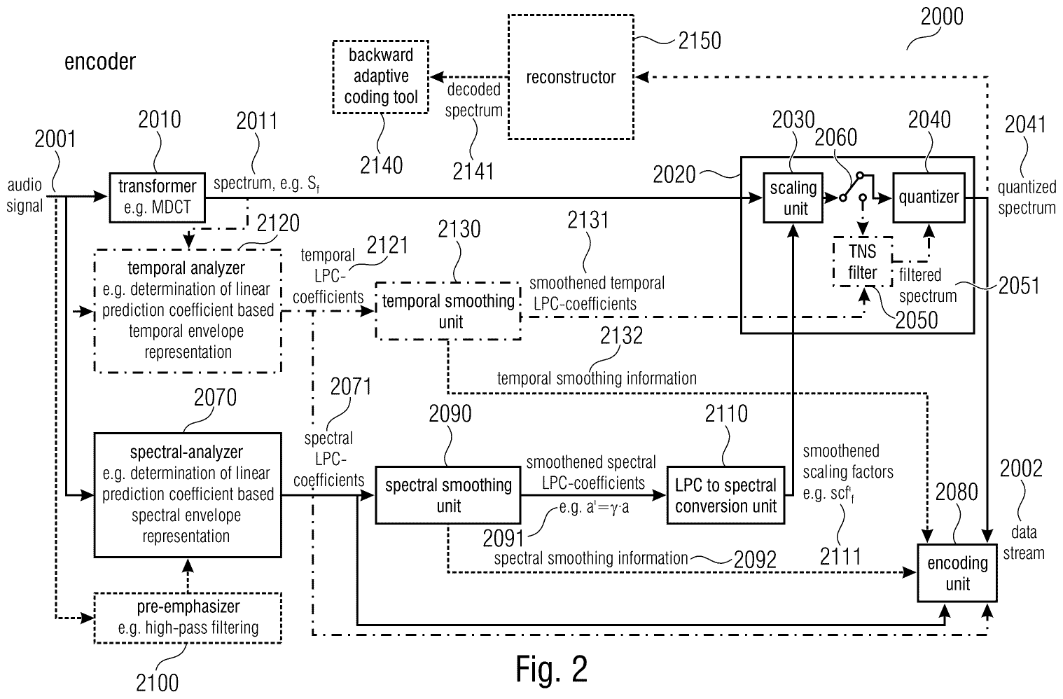

It is to be noted that a presence of envelope representations representing the envelopes both in spectral as well as temporal domain (as indicated by “-·-” lines) is optional and shown here for explanatory purpose. Further optional blocks are indicated with “- - - ” lines (This applies to FIG. 2 as well). In particular, a temporal domain noise shaping correction may be switchably activated and/or added in addition to a spectral domain noise shaping correction. To be more precise, according to one option, the audio decoder is configured to merely process a LPC based spectral envelope representation, according to a further option, the audio decoder is configured to merely process a LPC based temporal envelope representation, according to an even further option, the audio decoder is configured to process both a LPC based spectral envelope representation and a LPC based temporal envelope representation for one frame, and according to an even further option, the audio decoder is configured to process both a LPC based spectral envelope representation and a LPC based temporal envelope representation and merely one of the two, such as the spectral envelope representation, depending on a frame mode of the current/predetermined frame. According to the latter option, the decoder might be configured to expect the LPC based envelope representation for the predetermined/current frame to comprise a LPC based temporal envelope representation merely in case of the current frame being of a certain frame type as signaled in the data stream.

Furthermore, audio decoder 1000 comprises a locating unit 1020, which is configured to locate, in the quantized spectrum 1011, one or more zero-quantized portions 1021 and one or more non-zero-quantized portions 1022, i.e. determine the one or more zero-quantized portions 1021 and the one or more non-zero-quantized portions 1022 in terms of their spectral position or spectral interval they cover, respectively. The locating might involve some sort of analysis as briefly explained, or may simply be guided by default settings such as by default location(s) of the one or more zero-quantized portions 1021.

Optionally, the locating unit 1020 is configured to locate, in the quantized spectrum 1011, the one or more zero-quantized portions 1021 and the one or more non-zero-quantized portions 1022, by determining, for each of portions of the quantized spectrum, whether the respective portion is a zero-quantized portion or a non-zero-quantized portion, wherein the portions are individual spectral values of the quantized spectrum, or the portions are spectral bands of the quantized spectrum and the audio decoder 1000 is configured to, in determining, for each of portions of the quantized spectrum, whether the respective portion is a zero-quantized portion or a non-zero-quantized portion, appoint the respective portion a zero-quantized portion if all spectral values within the respective portion are zero, and a non-zero-quantized portion if not all spectral values within the respective portion are zero.

As another optional feature, locating unit 1020 may be configured to locate, in the quantized spectrum 1011, the zero-quantized portions 1021 by means of zero-portion location parameters in the data stream 1010. Hence, such parameters may be decoded by decoding unit 1010 and forwarded to locating unit 1020 (not shown).

In general, it is to be noted that, according to embodiments, the portions of the quantized spectrum 1011 (e.g. in particular the non-zero quantized portions 1022) may be restricted to lie above a predetermined frequency.

The audio decoder 1000 is configured to derive a dequantized spectrum 1031 using in zero-quantized portions 1021 of the quantized spectrum, filling the quantized spectrum with a synthesized spectral data modified depending, according to a first manner, on the linear prediction coefficient based envelope representation, and in non-zero-quantized portions 1022 of the quantized spectrum, modifying the quantized spectrum depending, in a second manner, on the linear prediction coefficient based envelope representation.

Therefore, decoder 1000 comprises a processing unit 1030, for example in the form of a noise shaping unit. The processing unit 1030 comprises modification units 1040 and 1050 and a dequantizer 1060. It is to be noted that a separation of the modification functionality in two different units 1040 and 1050 is optional and in particular shown in FIG. 1, in order to highlight the different modifications according to the first and second manner.

Furthermore, for the filling of the quantized spectrum in the zero-quantized portions 1021, the decoder further comprises a filling unit 1070, in order to provide a filled zero quantized portion 1071 to the processing unit 1030 and in particular to the modification unit 1050, for modification according to the first manner.

The filling unit 1070 may optionally be configured to determine or generate the synthesized spectral data using random or pseudo random noise, or copying from previously coded spectra in the bitstream 1001.

As another optional feature, decoder 1000 may be configured to determine the synthesized spectral data using piecewise spectral shaping for each contiguous interval of the zero-quantized portions 1021 with a unimodal shaping function having a outwardly-falling edges becoming zero at the respective contiguous interval's limits, and/or so that an overall level of the synthesized spectral patch of all zero-quantized portions corresponds to a level parameter transmitted in the data stream 1001; and/or using parametric coding syntax elements in the data stream 1001.

As shown, after modification, in the first manner, of the filled zero quantized portion 1071 and, in the second manner, the non-zero quantized portion 1022, the modified portions of the spectrum are provided to the dequantizer 1060, in order to provide the dequantized, and hence reconstructed, spectrum 1031, e.g. S_{f}.

For the respective modification of the respective portion 1021 (or filled version thereof 1071) and 1022, the processing unit 1030 is provided with an information about the linear prediction coefficient based envelope representation.

As explained before, the inventors recognized that a quality of a reconstructed audio frame 1301 may be improved, if a spectral and/or temporal quantization noise shaping is performed differently for the different portions 1021 (zero quantized) and 1022 (non-zero quantized). According to embodiments, different envelopes, e.g. a perceptual masking envelope and the signal envelope, may be used for a scaling of the zero quantized and non-zero quantized portion, in order to perform an individual noise shaping.

As shown, processing unit 1030 is provided with at least two sets of LPC coefficients, wherein based on the at least two sets of LPC coefficients a noise shaping of the zero quantized portion 1021 (and respectively 1071) is performed in a less smooth manner than a noise shaping of the non-zero quantized portion 1022.

With regard to an optional temporal noise shaping, the temporal LPC-coefficients 1013 and smoothened temporal LPC coefficients 1081 are provided as two sets of LPC-coefficients, to the processing unit 1030. As an example, decoder 1000 may be configured to determine the smoothened temporal LPC-coefficients 1081, using a temporal smoothing unit 1080, based on the temporal LPC coefficients 1013 and a temporal smoothing information 1014. As shown, as an optional feature, the temporal smoothing information 1014 may be provided via the data stream 1001 (and hence chosen adaptively), or as an alternative as a predetermined temporal smoothing information 1082, e.g. as a fixed parameter. Later on, this parameter will be exemplified as smoothing parameter of a bandwidth expansion.

In a corresponding manner, for an optional spectral noise shaping, as the two sets of LPC-coefficients, the spectral LPC-coefficients 1012 and smoothened spectral LPC-coefficients 1091 may be used. The smoothened spectral LPC-coefficients 1091 are determined, as an optional feature, based on the spectral LPC-coefficients 1012 and a spectral smoothing information, using a spectral smoothing unit 1090. In line with the above explanations, a spectral smoothing information 1015 may be included in the data stream 1001, or alternatively a predetermined, e.g. fixed, spectral smoothing information 1092 may be used (which may be fixedly defined for encoder and decoder). Later on, again, this parameter will be exemplified as smoothing parameter of a bandwidth expansion.

It is to be noted that neither the temporal smoothing information 1014, nor the spectral smoothing information 1015 do have to be included in the data stream 1001 (e.g. bitstream) (although they can be included, one and/or the other). Hence, such information 1014, 1015 may optionally not be decoded using decoding unit 1010. As an example, smoothing information 1014, 1015 may be known (and optionally fixed) for decoder 1000 and a corresponding encoder. Hence, smoothing information 1014, 1015 may comprise predetermined, e.g. fixedly defined, parameters. Although not being encoded (e.g. explicitly) in data stream 1001, respective smoothing information 1014, 1015 may, for example, be adaptable. For example, decoder 1000 and a corresponding encoder may agree upon one or more constants for a respective smoothing information 1014, 1015, e.g. based on a frame-bitrate. As an example, a respective encoder may set the smoothing information 1014, 1015 to one or more specific values, which may be determinable or derivable by the decoder 1000 based on a parameter included in the data stream 1001, or by a characteristic derivable from the data stream 1001, optionally, based on the frame-bitrate.

As optional features, the respective spectral LPC-coefficients 1012 and 1091 are converted to scaling factors, e.g. scf_{f}, 1101, e.g. scf′_{f} 1201, for the further processing in the processing unit 1030, using respective LPC to spectral conversion units 1100, 1200.

The modification according to the second manner may hence be performed using, as an example, the respective smoothened entities (coefficients 1081 and/or scaling factors 1201) and the modification according to the first manner may be performed using the one or both respective non-smoothened entities (coefficients 1013 and/or scaling factors 1101).

Alternatively, both modifications according to the first and second manner may be performed using either the smoothened or the non-smoothened entities (coefficients and/or scaling factors) and then either the modification according to the first manner or according to the second manner may be adapted using a correction factor which is determined based on a relationship between temporal LPC-coefficients 1013 and smoothened temporal LPC-coefficients 1081 and/or between scaling factors 1101 and smoothened scaling factors 1201 (and/or between spectral LPC-coefficients 1012 and smoothened spectral LPC-coefficients 1091).

Beyond that, respective correction factors may optionally be determined based on a respective smoothing information 1014, 1082, 1015, 1092.

Hence, in general, the audio decoder 1000 is configured so that, for a predetermined portion, the modification 1040 which is used in case of predetermined portion being a zero-quantized portion 1021, and depends, according to the first manner, on the linear prediction coefficient based envelope representation and the modification 1050 which is used in case of predetermined portion being a non-zero-quantized portion 1022, and depends, according to the second manner, on the linear prediction coefficient based envelope representation cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

With regard to the optional spectral noise shaping, as an example, the modification 1050 according to the first manner depending on the linear prediction coefficient based envelope representation, for example in the form of the scaling factors 1101 and 1201, may involve a spectral shaping using a first spectral shaping function and the modification 1040 according to the second manner, depending on the linear prediction coefficient based envelope representation, may involve a spectral shaping using a second spectral shaping function and the first spectral shaping function may be less smooth than the second spectral shaping function.

With regard to the optional temporal noise shaping, as an example, the modification 1050 according to the first manner, depending on the linear prediction coefficient based envelope representation, for example in the form of the temporal LPC-coefficients 1013 and 1081, may involve a filtering using a first filter and the modification 1040 according to the second manner, depending on the linear prediction coefficient based envelope representation, may involve a filtering using a second filter and a transfer function of the first filter may be less smooth than a transfer function of the second filter.

After modification, the dequantized spectrum 1031 may then be transformed, using a (reverse) transformer 1300, to a reconstructed audio-frame 1301, hence a reconstructed version of the predetermined encoded audio frame included in the data stream 1001. An inverse MDCT might be used for transformation, for example.

As an optional feature, reverse transformer 1300 may be configured to reconstruct the predetermined frame 1301 using the dequantized spectrum 1031 by applying a spectrum-to-time transformation to the quantized spectrum, and/or using an overlap-add aliasing cancellation process with respect to one or more temporally neighboring frames.

As another optional feature, decoder 1000 may comprise a backward adaptive coding tool 1400. Using the backward adaptive coding tool 1400, a correlation between already decoded frames and subsequently decoded frames, such as temporally following frames of the same audio channel or one or more frames of another channel, may, for example, be exploited in order to improve an efficiency of the decoding. Therefore, as shown, tool 1400 may be provided with spectrum 1031. For instance, such reconstructed spectrum 1031 may be used to perform synthesized filling of zero-quantized portions in subsequently decoded frames, or to perform MS (mid/side decoding) or to perform spectrum prediction and prediction residual decoding. As another optional feature, backward adaptive coding tool 1400 may be provided with additionally encoded parameters in order to perform or guide or control such an improved decoding, e.g. in the form of a prediction, e.g. from decoding unit 1010 which would decode such parameters from the data stream.

For example, using the optional backward adaptive coding tool 1400, decoder 1000 may be configured to perform a frequency-domain prediction, e.g. in accordance with MPEG-H Audio [2] and LTP in AAC. An approach in accordance with MPEG-H Audio may be used according to U.S. application Ser. No. 16/802,397. An approach according to “improved LTP” may be used according to Goran Markovic et al. (application, 2020/2021). According to embodiments, different variants may be used. As an example, a fundamental frequency parameter, for example a pitch information, may be used. Accordingly, a respective fundamental frequency information, e.g. pitch frequency information may be provided to the backward adaptive coding tool 1400. Such an information may be encoded in data stream 1001 and hence be decoded using decoding unit 1010.

Finally, it should be noted that the decoder of FIG. 1 might be configured to also process frames coded in a different manner such as without LPC envelope representation, similar to mode-switching codecs such as USAC, and/or to process frames coded using only LPC spectral envelope representation and frames using LPC spectral envelope representation plus LPC temporal envelope representation since, for example, the latter frames inherit an attack or the like so that the additional side information overhead which comes along with the transmission of the LPC based temporal envelope representation is overcompensated by the gain in terms of coding quality attained by the temporal noise shaping. Mode decisions such as the latter mode decisions are made on encoder side and transmitted, for instance, to decoder side via the data stream.

FIG. 2 shows an audio encoder according to embodiments of the invention. FIG. 2 shows an audio encoder 2000, which is configured to receive an audio signal 2001 and to transform the audio signal 2001 using a transformer 2010, in order to obtain a spectrum 2011.

The transformation performed by transformer 2010 may, for example, be a lapped transform. As an example, the transform may spectrally decompose the inbound original audio signal 2001 by subjecting consecutive, mutually overlapping transform windows of the original audio signal into a sequence of spectrums together composing a spectrogram.

With regard to frames and windows, it is to be noted that a window may actually go beyond a respective audio-frame and in this case the frames may not overlap but only the windows. However, windows and frames may also be considered synonymously, and in this case, the frames may overlap. The overlap may, for example, be 50%, but other variants are also possible. As an example, the number of coefficients of a frame may be half of the number of samples of the frame, hence equal to the number of “new” samples. For the following explanations, as an example, it is assumed that the predetermined audio-frame is a frame of a sequence of overlapping frames, together composing said spectrum.

The encoder 2000 is configured to encode a quantized version of the spectrum 2011 of a current frame into a data stream 2002. Therefore, spectrum 2011 is provided to a processing unit 2020, which comprises a scaling unit 2030, a quantizer 2040 and as optional features, a TNS filter 2050 and a switch 2060. It is to be noted that optionally, an order of scaling unit 2030 and TNS filter 2050 may be swapped, so that a respective spectrum 2011 is first TNS-filtered and then scaled (Also in this case, as will be discussed in the following, the TNS filter 2050 may be switchably activated, e.g. by shortcutting or not shortcutting the filter 2050 via the switch 2060 in front of the scaling unit 2030).

The spectrum 2011 is scaled using scaling factors, e.g. scf′_{f} 2111. As an optional feature, for the determination of the scaling factors, encoder 2000 comprises a spectral analyzer 2070. Analyzer 2070 is configured to perform a LPC analysis on the inbound audio signal 2001 so as to linearly predict the audio signal 2001 or, to be more precise, estimate its spectral envelope or its perceptual spectral envelope. The analyzer 2070 determines, for example in time units of sub-frames consisting of a number of audio samples of audio signal 2001, spectral LPC-coefficients 2071 and provides the same to an encoding unit 2080 for encoding into the data stream 2002, in order to be transmitted to a respective decoder.

The spectral-analyzer 2070 may be configured to determine the spectral LPC-coefficients 2071 using autocorrelation in analysis windows and using, for example, a Levinson-Durbin algorithm. The linear prediction coefficients 2071 may be transmitted in the data stream 2002 in a quantized and/or transformed version, such as in the form of spectral line pairs or the like.

As an optional feature, the encoder 2000 may comprise a pre-emphasizer 2100, which may be configured to provide a pre-processed version of the audio signal 2001 to the spectral analyzer 2070 for the determination of the LPC-coefficients 2071. As an example, the pre-emphasizer 2100 may be configured to perform a high-pass filtering of the audio signal 2001, for example with a shallow high pass filter transfer function using, for example, a FIR or IIR filter. As an example, an first-order high pass filter may be used for pre-emphasizer 156 such as H(z)=1−αz−1 with α setting, for example, the amount or strength of pre-emphasis in line with which, in accordance with one of the embodiments, a spectrally global tilt to which the noise or synthesized spectrum for being filled into the spectrum is subject, is varied. A possible setting of a could be 0.68. The pre-emphasis caused by pre-emphasizer 2100 may, for example, shift the energy of the quantized spectral values transmitted by encoder 2000, from a high to low frequencies, thereby taking into account psychoacoustic laws according to which human perception is higher in the low frequency region than in the high frequency region.

Furthermore, encoder 2000 is configured to provide the spectral LPC-coefficients 2071 to a spectral smoothing unit 2090 in order to obtain smoothened spectral LPC-coefficients 2091. Smoothing may, for example, be performed via a bandwidth expansion of the LPC filter coefficients 2071. Accordingly, a signal envelope as defined by spectral LPC-coefficients 2071 may be smoothened, for example in order to improve noise shaping characteristics in portions of the spectrum which are not quantized to zero. As an example, smoothing may be performed based on a fixed predetermined smoothing information. Alternatively, as shown in FIG. 2, respective smoothing parameters, or in general a spectral smoothing information 2092, may be adaptable and may hence, optionally, be forwarded to encoding unit 2080, in order to be provided to a respective decoder via data stream 2002.

As explained in the context of decoder 1000, it is to be noted that neither the temporal smoothing information 2132, nor the spectral smoothing information 2092 do have to be included in the data stream 2002 (e.g. bitstream) (although they can be included, one and/or the other). Hence, such information 2132, 2092 may optionally not be encoded using encoding unit 2080. As an example, smoothing information 2132, 2092 may be known (and optionally fixed) for encoder 2000 and a corresponding decoder, e.g. 1000. Hence, smoothing information 2132, 2092 may comprise predetermined, e.g. fixedly defined, parameters. Although not being encoded (e.g. explicitly) in data stream 1001, respective smoothing information 2132, 2092 may, for example, be adaptable. For example, encoder 2000 and a corresponding decoder may agree upon one or more constants for a respective smoothing information 2132, 2092, e.g. based on a frame-bitrate. As an example, the encoder 2000 may set the smoothing information 2132, 2092 to one or more specific values which may be determinable or derivable by a corresponding decoder, e.g. 1000, based on a parameter included in the data stream 2002, or by a characteristic derivable from the data stream 2002, optionally, based on the frame-bitrate.

The smoothened spectral LPC-coefficients 2091 are provided to a LPC to spectral conversion unit 2110 in order to obtain smoothened scaling factors 2111 e.g. scf′_{f}. The scaling factors 2111 may represent a spectral curve, e.g. a spectral envelope, for example, a perceptual spectral envelope of audio signal 2001 and are provided to the scaling unit 2030.

Scaling unit 2030, in combination with quantizer 2040 may determine a quantization step size of the spectrum 2011. As an example, the scaling unit may divide spectrum 2011 by the spectral curve as defined by scaling factors 2111 with the quantizer 2040, then using a spectrally constant quantization step size for the whole spectrum 2011.

When considered as a whole, scaling unit 2030 and quantizer 2040 may represent or may be seen as a quantization unit with spectrally varying quantization step size. Accordingly, as an example, the scaling factors 2111 represent a spectrally varying scaling function entering such a quantization unit with spectrally varying quantization step size, wherein the larger the this function is, the smaller the quantization step size is which his applied by quantization unit with spectrally varying quantization step size. Accordingly, the decoding side may optionally be informed of the variation of the quantization step size in the form of the scale factors which, by way of the just-described relationship between quantization step size on the one hand and spectral shaping function on the other hand, control the step size spectrally. Whatever view is applied, the scale factors may be defined at a spectral resolution which is lower than, or coarser than, the spectral resolution at which the quantized spectral levels of the quantized spectrum describe the spectral line-wise representation of the audio signal's spectrogram. For example, such scale factor bands may be bark bands. As described above, a global noise/synthesis level may be signaled to the decoding side in the bitstream, with this level indicating the noise level up to which zero-quantized portions of representation have to be filled, e.g. using filling unit 1070, with noise or other synthesized data before being rescaled, or by used of the corresponding scale factors, e.g. 1101 and 1201. The global level which may also be transmitted in the data stream 2002 for each spectrum, may indicate to the decoder the level up to which the zero-portions 1021 shall be filled with noise and/or synthesized spectral data modified before subjecting this filled spectrum to the rescaling or requantization using the scaling factors.

Irrespective of the above optional consideration, the quantized spectrum 2041 is then forwarded to encoding unit 2080 in order to be transmitted via data stream 2002 to a respective decoder.

Furthermore, for a quantization of the spectrum 2011, characteristics of the audio signal 2001 in temporal direction may optionally be considered as well. Therefore, encoder 2000 comprises an optional temporal analyzer 2120, an optional temporal smoothing unit 2130 and the before mentioned optional TNS filter 2050. Based on the audio signal 2001 and/or the spectrum 2011, the temporal analyzer 2120 may be configured to determine temporal LPC-coefficients 2121, e.g. TNS-LPC coefficients, representing TNS filter coefficients. Analogous to the spectral approach, the temporal shaping envelope of the temporal LPC-coefficients are smoothened, e.g. based on a bandwidth expansion of the coefficients or by windowing of autocorrelation functions. The latter approach may be integrated in temporal analyzer 2120 and hence the determination of the filter coefficients themselves. The smoothened temporal LPC-coefficients 2131 are then provided to the TNS filter 2050. As indicated by the switch 2060, an incorporation of a temporal noise shaping filtering using TNS filter 205 may be switchably activated or deactivated. As shown in FIG. 2, optionally, the scaled spectrum may be provided to TNS filter 2050 in order to obtain a filtered spectrum 2051 to be quantized.

Optionally, the temporal smoothing may be performed based on a predetermined smoothing parameter. Alternatively, as an optional feature, smoothing may be performed based on a temporal smoothing information 2132 which may be adaptable, and hence provided to encoding unit 2080 in order to make the information available via data stream 2002 for a respective decoder.

Furthermore, as an optional feature, the encoder 2000 may comprise a reconstructor 2150, which may comprise the same features as a decoder 1000 receiving data stream 2002—maybe except for one or more of the reverse transformer as the reconstruction of the spectrum of the current frame might suffice, the locating unit as the zero quantized portions might already have been “determined” otherwise and the decoding unit since the information recovered by the decoding unit is already available for the encoder (even in the form signaled such as the quantized form- and, which may be provided with the quantized spectrum 2041, in order to reconstruct the spectrum as explained in the context of FIG. 1 and to use the decoded spectrum 2141 in order to improve the encoding of the audio signal 2001. For example, as another optional feature, the encoder 2000 comprises an optional backward adaptive coding tool 2140, which may comprise one or more coding tools and which may allow to implement a feedback loop for the encoder 2000 in order to improve the encoding procedure. For example, the reconstructed spectrum might be used for the coding of one or more subsequent frames and as the reconstructed spectrum is also available to the decoder, the encoder would maintain synchronousity with the decoder. Corresponding to backward adaptive coding tool 2140, the decoder might have a corresponding backward adaptive coding tool 1400, as discussed before, so as to receive spectrum 1031 and perform the same sort of processing, for example prediction, as unit 2140. Therefore, respective parameters may be inserted in the bitstream by the unit 2140 for the corresponding unit at decoder side.

For example, using the optional backward adaptive coding tool 2140, encoder 2000 may be configured to perform a frequency-domain prediction, e.g. in accordance with MPEG-H Audio [2] and LTP in AAC. An approach in accordance with MPEG-H Audio may be used according to U.S. application Ser. No. 16/802,397. An approach according to “improved LTP” may be used according to Goran Markovic et al. (application, 2020/2021). According to embodiments, different variants may be used. As an example, a fundamental frequency parameter, for example a pitch information, may be used. Accordingly, a respective fundamental frequency information, e.g. pitch frequency information, may be provided to the backward adaptive coding tool 2140 (and optionally be determined based on the audio signal 2001 by encoder 2000). Such an information may be encoded in data stream 2002.

In general, it is to be noted that the examples as shown in FIGS. 1 and 2 having respective smoothing units are to be considered as optional. No explicit smoothing may be performed and yet, different spectral LPC coefficients and/or temporal LPC coefficients may be used for the decoding of zero quantized and non-zero quantized portions.

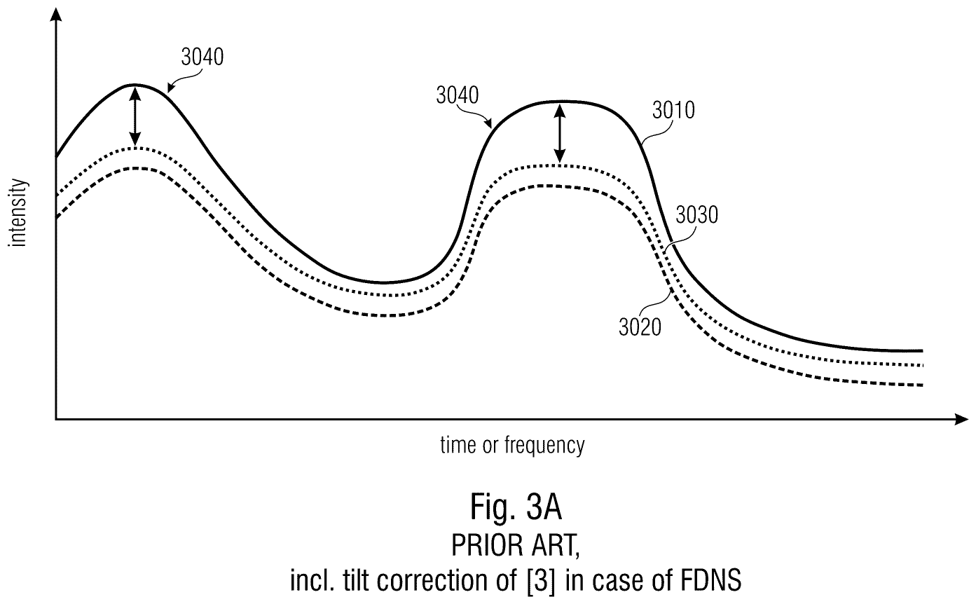

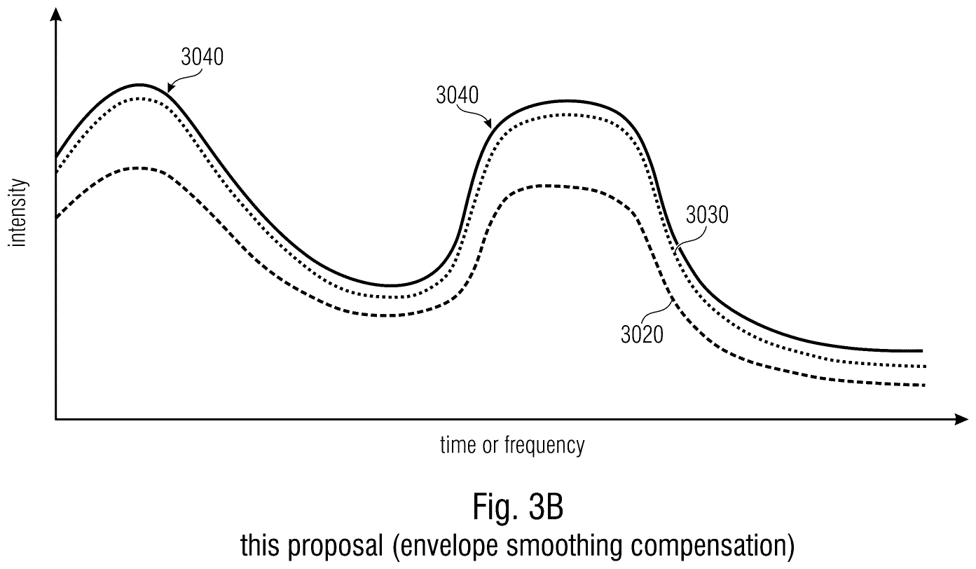

FIG. 3 a, b illustrates operation of the proposal according to an embodiment in both spectral and temporal direction. FIG. 3 a, b shows schematic examples of intensities over time or frequency, according to conventional approaches, FIG. 3 a, and according to embodiments of the invention, FIG. 3 b. FIG. 3 a, b, shows a spectrotemporal shaping in audio transform coding: (-) input signal envelope 3010, modeled by envelope of a linear predictive filter, (-) decoder-side shaping 3020 of non-zero quantized transform coefficients for quantization noise shaping, (-) decoder-side shaping 3030 of noise filled and other zero quantized transform coefficient regions as part of parametric coding methods. Note how in (a), spectrotemporal peaks 3040 are smoothened by conventional solutions, i. e., that parametrically coded audio regions fail to reconstruct the input signal envelope, and how the present design, hence embodiments according to the invention, as shown in (b) allows parametric coders to follow the input envelope.

As can be seen, the improved spectrotemporal shaping, e.g. as shown by 3030, recovers more accurately the original spectral and temporal frame envelopes, e.g. as shown by 3010, in the zero-quantized spectral regions, e.g. 1021, i.e., in spectral regions encoded and decoded by means of parametric coding schemes. In other words and as an example, a distance between envelope 3010 and shaped spectrum 3030 is reduced by applying the inventive approach as shown in FIG. 3 b, in contrast to conventional solutions, as shown in FIG. 3 a.

In the following it is assumed that spectral shaping, when applied, is based on a linear predictive coding envelope LPC_{f}, as discussed earlier, and that temporal shaping, when (hence optionally and/or switchably) applied, is based on a temporal noise shaping filter TNS_{f}. In other words, it is assumed that reconstructive spectral shaping is performed via frequency-domain noise shaping (FDNS), i.e., via multiplication of quantized spectrum S_{f} by the transfer function of the LPC_{f} (called envelope) associated with S_{f}. Likewise, reconstructive temporal shaping of the quantized and possibly spectrally shaped spectrum S_{f} is carried out by filtering the S_{f} with the TNS filter TNS_{f}, i.e., via convolution of S_{f} with the impulse response of TNS_{f}.

In other words, according to embodiments of the invention, spectral shaping may be performed based on a linear predictive coding envelope and temporal shaping may be switchably (e.g. 2060) activated or deactivated. Furthermore, optionally, for the temporal shaping, e.g. noise shaping, a temporal noise shaping filter, e.g. 2050, may be used.

Accordingly, spectral noise shaping may be performed based on a multiplication of the quantized spectrum, e.g. 1011 or portions thereof, e.g. 1021, 1022, 1071, with a transfer function of the LPC, or in other words coefficients, e.g. 1012, 1091, representing such a transfer function, or for example, scaling factors, e.g. 1101, 1201, derived based on the said coefficients or such a transfer function.

Furthermore, in accord with the above, in other words, temporal shaping, e.g. temporal noise shaping may be performed based on a convolution of the quantized spectrum, e.g. 1011 or portions thereof, e.g. 1021, 1022, 1071, with a transfer function of a temporal filter, e.g. represented by an impulse response.

As an example, in the transform coded excitation (TCX) core of the EVS and MPEG-H Audio coding standards, the frame-wise or subframe-wise LPC_{f} envelope may be calculated from the high pass filtered (e.g. using a pre-emphasizer 2100) input signal, e.g. 2001, for example via typical linear predictive coding methods, optionally with additional bandwidth expansion, e.g. using respective smoothing units 1080, 1090, of the LPC filter coefficients in order to smoothen said envelope:

$${a}_{k}^{′} = {a}_{k} \cdot {γ}^{k} with 0 \leq k \leq K and K being the filter order , \qquad equation ( 1 )$$

where a are the direct-form LPC filter coefficients and γ is a constant value, e.g. a smoothing parameter, close to but less than one (e.g., 0.92). The spectrally smoothened LPC envelope of (1) may then be used in the FDNS for the multiplicative scaling (e.g. in scaling unit 2030 and modification unit 1040) of the quantized and reconstructed spectrum S_{f}. The same approach may be pursued to smoothen the temporal shaping envelope in TNS, although bandwidth expansion (e.g. using temporal smoothing unit 1080) of the TNS filter coefficients (e.g. 1013) may be achieved by traditional windowing of autocorrelation functions already during the TNS filter calculation. Hence, either bandwidth expansion or autocorrelation windowing may be used in TNS. Envelope smoothing compensation in zero-quantized spectral regions (e.g. 1021) may be realized as follows, depending on whether spectral and/or temporal shaping is being applied. Let S_{f} and γ be, again, the quantized spectrum and bandwidth expansion values, respectively.

Example for spectral shaping, using LPC_{f}:
Let scf_{f} denote a transfer function of spectral envelope LPC_{f} for each processed frame f, derived from LPC_{f} using, e.g., a Fourier-like transform (e.g. as performed by transformer 1300 and inversely 2010) such as a DCT, FFT, or MDCT and let scf_{f} represent scale factors (or in other words scale factors) (e.g. 1101) to be multiplied onto S_{f} (e.g. 1011, 2011), where each value of scf_{f} is associated with one or more spectral coefficients in S_{f}. Moreover let a (e.g. 1012, e.g. 2071) be the coefficients of LPC_{f}, advantageously in a direct-form filter notation. There are two equivalent options for embodiments and hence embodiments presented in the following:
1. * obtain the transfer-function scale factors scf_{f} (e.g. 1101) from a via a Fourier-like transform (e.g. using conversion unit 1100),
   apply bandwidth expansion (e.g. using spectral smoothing unit 1090) to a according to equn. (1), resulting in weighted a′ (e.g. 1091),
   obtain transfer-function scale factors scf′_{f} (e.g. 1201) from a′ via said Fourier-like transform (e.g. using conversion unit 1200),
   apply parametric decoding (e.g.NF) to at least one zero-quantized sample (e.g. 1021) in S_{f} (e.g. 1011),
   multiply each quantized sample in S_{f} by the resp. associated scale factor in scf′_{f},
   multiply at least one zero-quantized, and parametrically (de)coded, sample in S_{f} by the corrective ratio (scf_{f}/scf′_{f})^{β} associated with that sample, where −2<β<2.

Here, the corrective ratio scf_{f}/scf′_{f} is a scale-factor-wise smoothing compensating ratio. Hence, as an example, modification in the first manner may comprise the multiplication of each quantized sample in S_{f} by the resp. associated scale factor in scf′_{f} and modification in the second manner may comprise multiplication of each quantized sample in S_{f} by the resp. associated scale factor in scf′_{f} and ans subsequent correction using the corrective ratio.
2. * obtain the transfer-function scale factors scf_{f} (e.g. 1101) from a via a Fourier-like transform,
   apply bandwidth expansion (e.g. using spectral smoothing unit 1090) to a according to equn. (1), resulting in weighted a′ (e.g. 1091),
   obtain transfer-function scale factors scf′_{f} (e.g. 1201) from a′ via said Fourier-like transform (e.g. using conversion unit 1200),
   apply parametric decoding (e.g.NF) to at least one zero-quantized sample (e.g. 1021) in S_{f} (e.g. 1011),
   multiply each nonzero-quantized sample (e.g. 1022) in S_{f} by the resp. associated scale factor in scf′_{f} (e.g. 1201) (as in 1 above, the scf′_{f} vector denotes the spectral masking envelope) (e.g. representing the modification in the second manner),
   multiply at least one zero-quantized (e.g. 1021), and parametrically (de)coded, sample in S_{f} by the associated scale factor in scf_{f} (e.g. 1101) (holding as in 1 the spectral signal envelope) (e.g. representing the multiplication in the first manner).

Hence, the nonzero-quantized and zero-quantized samples in S_{f} are scaled differently.

Hence, in general, embodiments comprise an audio decoder, e.g. 1000, configured to, for a predetermined frame among consecutive frames, decode, from a data stream, e.g. 1001, a quantized spectrum, e.g. 1011; a linear prediction coefficient based spectral envelope representation, locate, in the quantized spectrum, one or more zero-quantized portions, e.g. 1021, and one or more non-zero-quantized portions, e.g. 1022, derive a dequantized spectrum, e.g. 1031, using in zero-quantized portions of the quantized spectrum, filling the quantized spectrum with a synthesized spectral data spectrally shaped using a first spectral shaping function which depends, according to a first manner, on the linear prediction coefficient based spectral envelope representation, and in non-zero-quantized portions of the quantized spectrum, spectrally shaping the quantized spectrum using a second spectral shaping function which depends, in a second manner, on the linear prediction coefficient based spectral envelope representation, reconstruct the predetermined frame, e.g. 1301, using the dequantized spectrum, wherein the audio decoder is configured so that the first spectral shaping function is different from, e.g. less smooth, than the second spectral shaping function. Accordingly, a respective encoder 2000 may be provided.

Furthermore, optionally, the first and second spectral shaping functions may be defined by scale factors, hence, for example scaling factors 1101 and 1201, comprising one scale factor per scale factor band. Hence, referring to FIG. 1, processing unit 1030 may be configured to derive the first spectral shaping function for the modification in the first manner based on scaling factors 1101 and the second spectral shaping function for the modification in the second manner based on scaling factors 1201.

Moreover, as another optional feature, with regard to spectral noise shaping correction, the decoder 1000 may be configured to derive the second spectral shaping function from the linear prediction coefficient based spectral envelope representation, e.g. coefficients 1012, by means of bandwidth expansion (e.g. using spectral smoothing unit 1090, for example, in combination with spectral smoothing information 1015, e.g. a factor γ^{k} or γ), and derive the first spectral shaping function from the linear prediction coefficient based spectral envelope representation, e.g. coefficients 1012, without the bandwidth expansion.

Alternatively, decoder 1000 may be configured to derive the second spectral shaping function from the linear prediction coefficient based spectral envelope representation, e.g. coefficients 1012, by means of bandwidth expansion and derive the first spectral shaping function as a product of the second spectral shaping function and a compensation function, e.g. a quotient (scf_{f}/scf′_{f})^{β}, which, by means of the concatenation, reduces a smoothing of the second spectral shaping function resulting from the bandwidth expansion.

Accordingly, in other words, embodiments may be based on the finding to use different spectral envelopes for a noise shaping of zero quantized and non-zero quantized portions of the spectrum. Different scalings, as defined by respective different envelopes, may be represented using LPC filter coefficients and/or scaling or scale factors. Furthermore, the different modifications, according to the different envelopes, may be performed based on a common scaling with subsequent compensation or different scalings.

Example for temporal shaping, using TNS_{f}:

With TNS, convolution may be used instead of multiplications. Again two options for embodiments and hence embodiments are presented in the following:
1. * apply parametric decoding (e.g. NF) to at least one zero-quantized sample (e.g. 1021) in S_{f} (e.g. 1011),
   apply bandwidth expansion (e.g. using smoothing unit 1080) to a (e.g. 1013) according to equn. (1), resulting in weighted a′ (e.g. 1081),
   apply TNS decoding by IIR filtering at least one contiguous region in S_{f} by 1/a′_{z},
   identify at least one further contiguous region in the at least one contiguous region in which all samples of S_{f} are zero-quantized (e.g. 1021) and parametrically (de)coded,
   compensate for smoothing by IIR filtering all samples in the at least one further contiguous region by filter a′_{z}/a_{z} or a lower-complexity approximation thereof.

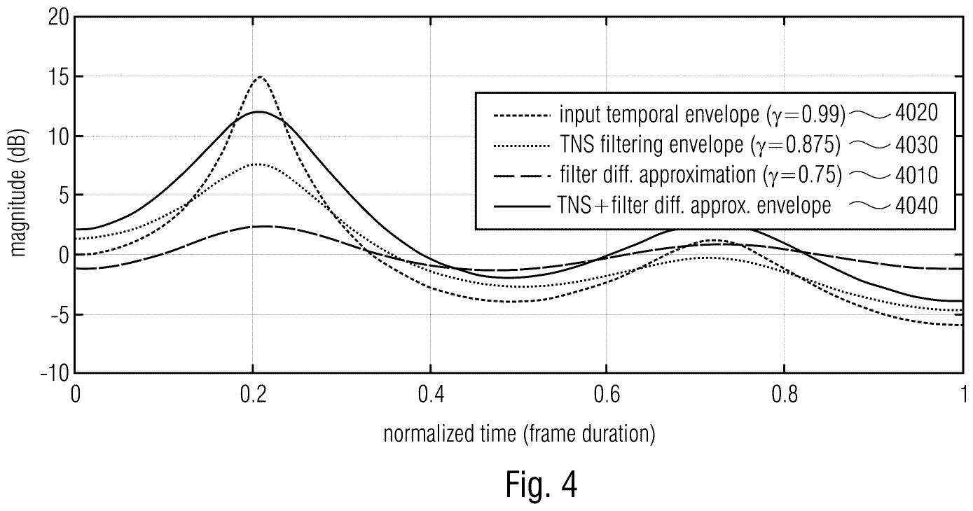

Here, a are the coefficients of TNS_{f}, not LPC_{f}, advantageously in a direct-form filter notation. Note that, effectively, zero-quantized and parametrically (de)coded samples are filtered twice and that the lower-complexity approximation may be achieved by processing a′ (e.g. 1081) by (1) a second time, with a smaller γ≈¾, yielding b/a″_{z}≈a′_{z}/a_{z} (e.g. 2132) as illustrated in FIG. 4. Note that a tilt correction can be applied while deriving b/a″z such that b=1 when not using tilt correction, and b=1st-order filter [1, Σ_{0≤k<K} a″ₖ·a″ₖ₊₁/Σ_{0≤k≤K} a″ₖ·a″ₖ] otherwise.

FIG. 4 shows schematic examples of magnitudes in dB over normalized time (frame duration). FIG. 4 shows an example for a smoothing compensation in temporal noise shaping (TNS) of an embodiment according to option 1. The yellow curve, e.g. 4010, is the compensation envelope b/a″_{z}, incl. tilt correction according to the present example (Temporal shaping, using TNS_{f}—Filter diff. approximation (γ=0.75)). Curve 4020 shows an input temporal envelope (γ=0.99), curve 4030 shows a TNS filtering envelope (γ=0.875) and curve 4040 shows a TNS+filter diff. approx. envelope. In other words, FIG. 4 shows the transfer function of the TNS LPC filters, the one—input temporal envelope (γ=0.99)—used for non-zero-quantized portions, and the one—TNS filtering envelope (γ=0.875)—used for the zero-quantized portions. The transfer functions represent a temporal envelope of the audio signal with the current frame. Thus, FIG. 4 shows a graph whose x axis represents the time (of the current frame), and whose y axis measures the temporal envelope in arbitrary units. As con be seen, the temporal envelope used for the zero-quantized portions is less smooth. FIG. 4 also shows possible TNS correction filter's transfer functions to turn a dequantized spectrum filtered using the smoothened TNS LPC filter into a dequentized spectrum filtered using a less smoothening TNS filter.
2. * identify at least one first contiguous region in S_{f} with all samples being nonzero (e.g. 1022),
   apply parametric decoding (e.g. NF) to at least one zero-quantized sample in S_{f},
   apply bandwidth expansion (e.g. using smoothing unit 1080) to a (e.g. 1013) according to equn. (1), resulting in weighted a′ (e.g. 1081),
   apply TNS decoding to only nonzero-quantized samples in S_{f} by filtering all samples in the at least one first contiguous region by a FIR filter a′_{z} or IIR filter 1/a′_{z},
   identify at least one further contiguous region in S_{f} in which all samples of S_{f} are zero-quantized (e.g. 1021) and parametrically (de)coded, i.e., have been zero in the 1st step,
   apply TNS decoding to only zero-quantized samples in S_{f} by filtering all samples in the at least one further contiguous region by a FIR filter a_{z} or an IIR filter 1/a_{z}.

Again, with suitable parametrization, the two approaches may be equivalent. In both cases, FIR stands for finite impulse response, i.e., resulting in all-zero filtering, while IIR stands for infinite impulse response, i.e., resulting in all-pole (denominator-only) or zero-pole (numerator-denominator) filtering. Subscript z, finally, denotes the filter delay notation.

Hence, in general embodiments comprise an audio decoder, e.g. 1000, configured to, for a predetermined frame among consecutive frames, decode, from a data stream, e.g. 1001, a quantized spectrum, e.g. 1011; a linear prediction coefficient based temporal envelope representation, locate, in the quantized spectrum, one or more zero-quantized portions, e.g. 1021, and one or more non-zero-quantized portions, e.g. 1022, derive a dequantized spectrum, e.g. 1031, using in zero-quantized portions of the quantized spectrum, filling the quantized spectrum with a synthesized spectral data filtered using a first filter which depends, according to a first manner, on the linear prediction coefficient based temporal envelope representation, and in non-zero-quantized portions of the quantized spectrum, filtering the quantized spectrum using a second filter which depends, in a second manner, on the linear prediction coefficient based temporal envelope representation, reconstruct the predetermined frame, e.g. 1301, using the dequantized spectrum, wherein the audio decoder is configured so that a transfer function of the first filter is different from, e.g. less smooth than, a transfer function of the second filter. Accordingly, a respective encoder, e.g. 2000, may be provided.

Optionally, the first and second filters may be FIR filters or IIR filters. Moreover, analogous to the above explanations with regard to spectral noise shaping, a decoder according to embodiments, e.g. decoder 1000, may optionally be configured to derive the second filter from the linear prediction coefficient based temporal envelope representation, e.g. 1013, by means of bandwidth expansion, e.g. using temporal smoothing unit 1080, and to derive the first filter from the linear prediction coefficient based temporal envelope representation, e.g. 1030, without the bandwidth expansion.

Alternatively, decoder 1000 may be configured to derive the second filter from the linear prediction coefficient based temporal envelope representation by means of bandwidth expansion and derive the first filter as a concatenation of the second filter and a compensation filter (e.g. with a compensation according to a′_{z}/a_{z}) which, by means of the concatenation, reduces a smoothing of the second filter's transfer function resulting from the bandwidth expansion.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] 3GPP, ETSI TS (1)26.445, “EVS Codec: Detailed algorithmic description,” May 2022.
[2] ISO/IEC (MPEG-H), International Standard 23008-3:2022, “High efficiency coding and media delivery in heterogeneous environments—Part 3: 3D audio,” August 2022.
[3] PCT/EP 2022/052149, “Method and Apparatus for Spectrotemporally Improved Spectral Gap Filling in Audio Coding using a Tilt,” priority EP21217659.8, January 2022.

1. Audio decoder configured to, for a predetermined frame among consecutive frames,
decode, from a data stream,
a quantized spectrum;
a linear prediction coefficient based envelope representation,
locate, in the quantized spectrum, one or more zero-quantized portions and one or more non-zero-quantized portions,
derive a dequantized spectrum using
in zero-quantized portions of the quantized spectrum,
filling the quantized spectrum with a synthesized spectral data modified depending, according to a first manner, on the linear prediction coefficient based envelope representation, and
in non-zero-quantized portions of the quantized spectrum,
modifying the quantized spectrum depending, in a second manner, on the linear prediction coefficient based envelope representation,
reconstruct the predetermined frame using the dequantized spectrum,
wherein the audio decoder is configured so that, for a predetermined portion,
the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation
cause a spectral quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or
cause a temporal quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

2. Audio decoder of claim 1, wherein the audio decoder is configured so that, for the predetermined portion,
the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation
cause a spectral quantization noise shaping which is less smooth for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or
cause a temporal quantization noise shaping which is less smooth for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

3. Audio decoder of claim 1, wherein
the linear prediction coefficient based envelope representation comprises a linear prediction coefficient based spectral envelope representation,
the modification which is used in case of predetermined portion being a zero-quantized portion, and depends, according to the first manner, on the linear prediction coefficient based envelope representation involves a spectral shaping using a first spectral shaping function which depends on the linear prediction coefficient based spectral envelope representation, and
the modification which is used in case of predetermined portion being a non-zero-quantized portion, and depends, according to the second manner, on the linear prediction coefficient based envelope representation involves a spectral shaping using a second spectral shaping function which depends on the linear prediction coefficient based spectral envelope representation, and
the first spectral shaping function is less smooth than the second spectral shaping function.

4. Audio decoder configured to, for a predetermined frame among consecutive frames,
decode, from a data stream,
a quantized spectrum;
a linear prediction coefficient based spectral envelope representation,
locate, in the quantized spectrum, one or more zero-quantized portions and one or more non-zero-quantized portions,
derive a dequantized spectrum using
in zero-quantized portions of the quantized spectrum,
filling the quantized spectrum with a synthesized spectral data spectrally shaped using a first spectral shaping function which depends, according to a first manner, on the linear prediction coefficient based spectral envelope representation, and
in non-zero-quantized portions of the quantized spectrum,
spectrally shaping the quantized spectrum using a second spectral shaping function which depends, in a second manner, on the linear prediction coefficient based spectral envelope representation,
reconstruct the predetermined frame using the dequantized spectrum,
wherein the audio decoder is configured so that the first spectral shaping function is different from, e.g. less smooth than, the second spectral shaping function.

5. Audio decoder of claim 3, configured so that the first and second spectral shaping functions are defined by scale factors comprising one scale factor per scale factor band.

6. Audio decoder of claim 3, configured to
derive the second spectral shaping function from the linear prediction coefficient based spectral envelope representation by means of bandwidth expansion and derive the first spectral shaping function from the linear prediction coefficient based spectral envelope representation without the bandwidth expansion or
derive the second spectral shaping function from the linear prediction coefficient based spectral envelope representation by means of bandwidth expansion and derive the first spectral shaping function as a product of the second spectral shaping function and a compensation function which, by means of the concatenation, reduces a smoothing of the second spectral shaping function resulting from the bandwidth expansion.

7. Audio decoder of claim 1, wherein
the linear prediction coefficient based envelope representation comprises a linear prediction coefficient based temporal envelope representation,
the modification which is used in case of predetermined portion being a zero-quantized portion, and depends, according to the first manner, on the linear prediction coefficient based envelope representation involves a filtering using a first filter which depends on the linear prediction coefficient based temporal envelope representation, and
the modification which is used in case of predetermined portion being a non-zero-quantized portion, and depends, according to the second manner, on the linear prediction coefficient based envelope representation involves a filtering using a second filter which depends on the linear prediction coefficient based temporal envelope representation, and
a transfer function of the first filter is less smooth than a transfer function of the second filter.

8. Audio decoder configured to, for a predetermined frame among consecutive frames,
decode, from a data stream,
a quantized spectrum;
a linear prediction coefficient based temporal envelope representation,
locate, in the quantized spectrum, one or more zero-quantized portions and one or more non-zero-quantized portions,
derive a dequantized spectrum using
in zero-quantized portions of the quantized spectrum,
filling the quantized spectrum with a synthesized spectral data filtered using a first filter which depends, according to a first manner, on the linear prediction coefficient based temporal envelope representation, and
in non-zero-quantized portions of the quantized spectrum,
filtering the quantized spectrum using a second filter which depends, in a second manner, on the linear prediction coefficient based temporal envelope representation,
reconstruct the predetermined frame using the dequantized spectrum,
wherein the audio decoder is configured so that a transfer function of the first filter is different from, e.g. less smooth than, a transfer function of the second filter.

9. Audio decoder of claim 7, configured so that the first and second filters are
FIR filters or
IIR filters.

10. Audio decoder of claim 7, configured to
derive the second filter from the linear prediction coefficient based temporal envelope representation by means of bandwidth expansion and derive the first filter from the linear prediction coefficient based temporal envelope representation without the bandwidth expansion or
derive the second filter from the linear prediction coefficient based temporal envelope representation by means of bandwidth expansion and derive the first filter as a concatenation of the second filter and a compensation filter which, by means of the concatenation, reduces a smoothing of the second filter's transfer function resulting from the bandwidth expansion.

11. Audio decoder of claim 1, configured to locate, in the quantized spectrum, the zero-quantized portions and the non-zero-quantized portions, by determining, for each of portions of the quantized spectrum, whether the respective portion is a zero-quantized portion or a non-zero-quantized portion, wherein
the portions are individual spectral values of the quantized spectrum, or
the portions are spectral bands of the quantized spectrum and the audio decoder is configured to, in determining, for each of portions of the quantized spectrum, whether the respective portion is a zero-quantized portion or a non-zero-quantized portion, appoint the respective portion a zero-quantized portion if all spectral values within the respective portion are zero, and a non-zero-quantized portion if not all spectral values within the respective portion are zero.

12. Audio decoder of claim 1, configured to locate, in the quantized spectrum, the zero-quantized portions
by means of zero-portion location parameters in the data stream.

13. Audio decoder of claim 1, configured so that the portions of the quantized spectrum are restricted to lie above a predetermined frequency.

14. Audio decoder of claim 1, configured to determine the synthesized spectral data using
random or pseudo random noise, or
copying from previously coded spectra in the bitstream.

15. Audio decoder of claim 1 configured to determine the synthesized spectral data
Using piecewise spectral shaping for each contiguous interval of the zero-quantized portions with a unimodal shaping function having a outwardly-falling edges becoming zero at the respective contiguous interval's limits, and/or
so that an overall level of the synthesized spectral patch of all zero-quantized portions corresponds to a level parameter transmitted in the data stream; and/or
using parametric coding syntax elements in the data stream.

16. Audio decoder of claim 1, configured to
Decode, from the data stream, the quantized spectrum
by entropy decoding and/or
in form of spectral coefficient levels of an MDCT.

17. Audio decoder of claim 1, configured to reconstruct the predetermined frame using the dequantized spectrum by
applying a spectrum-to-time transformation to the quantized spectrum, and/or
using an overlap-add aliasing cancellation process with respect to one or more temporally neighbouring frames.

18. Audio encoder configured to, for a predetermined frame among consecutive frames,
encode, into a data stream,
a quantized spectrum;
a linear prediction coefficient based envelope representation,
locate, in the quantized spectrum, zero-quantized portions and non-zero-quantized portions,
derive a dequantized spectrum using
in zero-quantized portions of the quantized spectrum,
filling the quantized spectrum with a synthesized spectral data modified depending, according to a first manner, on the linear prediction coefficient based envelope representation, and
in non-zero-quantized portions of the quantized spectrum,
modifying the quantized spectrum depending, in a second manner, on the linear prediction coefficient based envelope representation,
use the dequantized spectrum for encoding further frames,
wherein the audio encoder is configured so that, for a predetermined portion,
the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation
cause a spectral quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or
cause a temporal quantization noise shaping which is different for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

19. Audio encoder configured to, for a predetermined frame among consecutive frames,
encode, into a data stream,
a quantized spectrum;
a linear prediction coefficient based spectral envelope representation,
locate, in the quantized spectrum, zero-quantized portions and non-zero-quantized portions,
derive a dequantized spectrum using
in zero-quantized portions of the quantized spectrum,
filling the quantized spectrum with a synthesized spectral data spectrally shaped using a first spectral shaping function which depends, according to a first manner, on the linear prediction coefficient based spectral envelope representation, and
in non-zero-quantized portions of the quantized spectrum,
spectrally shaping the quantized spectrum using a second spectral shaping function which depends, in a second manner, on the linear prediction coefficient based spectral envelope representation,
use the dequantized spectrum for encoding further frames,
wherein the audio encoder is configured so that the first spectral shaping function is less smooth than the second spectral shaping function.

20. Audio encoder configured to, for a predetermined frame among consecutive frames,
encode, into a data stream,
a quantized spectrum;
a linear prediction coefficient based temporal envelope representation,
locate, in the quantized spectrum, zero-quantized portions and non-zero-quantized portions,
derive a dequantized spectrum using
in zero-quantized portions of the quantized spectrum,
filling the quantized spectrum with a synthesized spectral data filtered using a first filter which depends, according to a first manner, on the linear prediction coefficient based temporal envelope representation, and
in non-zero-quantized portions of the quantized spectrum,
filtering the quantized spectrum using a second filter which depends, in a second manner, on the linear prediction coefficient based temporal envelope representation,
use the dequantized spectrum for encoding further frames,
wherein the audio encoder is configured so that a transfer function of the first filter is less smooth than a transfer function of the second filter.

21. Method for a predetermined frame among consecutive frames, wherein the method comprises:
decoding, from a data stream,
a quantized spectrum, and
a linear prediction coefficient based envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data modified depending, according to a first manner, on the linear prediction coefficient based envelope representation, and
in non-zero-quantized portions of the quantized spectrum,
modifying the quantized spectrum depending, in a second manner, on the linear prediction coefficient based envelope representation,
reconstructing the predetermined frame using the dequantized spectrum,
wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation
cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or
cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

22. Method for a predetermined frame among consecutive frames, wherein the method comprises:
decoding, from a data stream,
a quantized spectrum,
a linear prediction coefficient based spectral envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data spectrally shaped using a first spectral shaping function which depends, according to a first manner, on the linear prediction coefficient based spectral envelope representation, and
in non-zero-quantized portions of the quantized spectrum,
spectrally shaping the quantized spectrum using a second spectral shaping function which depends, in a second manner, on the linear prediction coefficient based spectral envelope representation;
reconstructing the predetermined frame using the dequantized spectrum;
wherein the first spectral shaping function is different from, e.g. less smooth than, the second spectral shaping function.

23. Method for a predetermined frame among consecutive frames, wherein the method comprises:
decoding, from a data stream,
a quantized spectrum and
a linear prediction coefficient based temporal envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data filtered using a first filter which depends, according to a first manner, on the linear prediction coefficient based temporal envelope representation, and
in non-zero-quantized portions of the quantized spectrum,
filtering the quantized spectrum using a second filter which depends, in a second manner, on the linear prediction coefficient based temporal envelope representation;
reconstructing the predetermined frame using the dequantized spectrum;
wherein a transfer function of the first filter different from, e.g. is less smooth than, a transfer function of the second filter.

24. Method for a predetermined frame among consecutive frames, wherein the method comprises:
encoding, into a data stream,
a quantized spectrum and
a linear prediction coefficient based envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data modified depending, according to a first manner, on the linear prediction coefficient based envelope representation, and
in non-zero-quantized portions of the quantized spectrum
modifying the quantized spectrum depending, in a second manner, on the linear prediction coefficient based envelope representation;
using the dequantized spectrum for encoding further frames,
wherein the method is performed so that, for a predetermined portion, the modification which is used in case of predetermined portion being a zero-quantized portion, and depends, according to the first manner, on the linear prediction coefficient based envelope representation and the modification which is used in case of predetermined portion being a non-zero-quantized portion, and depends, according to the second manner, on the linear prediction coefficient based envelope representation
cause a spectral quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation, and/or
cause a temporal quantization noise shaping which is different, e.g. less smooth, for the modification which is used in case of predetermined portion being a zero-quantized portion, and depends, according to the first manner, on the linear prediction coefficient based envelope representation than for the modification which is used in case of predetermined portion being a non-zero-quantized portion, and depends, according to the second manner, on the linear prediction coefficient based envelope representation.

25. Method for a predetermined frame among consecutive frames, wherein the method comprises:
encoding, into a data stream,
a quantized spectrum, and
a linear prediction coefficient based spectral envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data spectrally shaped using a first spectral shaping function which depends, according to a first manner, on the linear prediction coefficient based spectral envelope representation, and
in non-zero-quantized portions of the quantized spectrum,
spectrally shaping the quantized spectrum using a second spectral shaping function which depends, in a second manner, on the linear prediction coefficient based spectral envelope representation;
using the dequantized spectrum for encoding further frames;
wherein the first spectral shaping function is different from, e.g. less smooth than, the second spectral shaping function.

26. Method for a predetermined frame among consecutive frames, wherein the method comprises:
encoding, into a data stream,
a quantized spectrum and
a linear prediction coefficient based temporal envelope representation;
locating, in the quantized spectrum, one or more zero-quantized portions and one or more non-zero-quantized portions,
deriving a dequantized spectrum using
in zero-quantized portions of the quantized spectrum,
filling the quantized spectrum with a synthesized spectral data filtered using a first filter which depends, according to a first manner, on the linear prediction coefficient based temporal envelope representation, and
in non-zero-quantized portions of the quantized spectrum,
filtering the quantized spectrum using a second filter which depends, in a second manner, on the linear prediction coefficient based temporal envelope representation;
using the dequantized spectrum for encoding further frames;
wherein a transfer function of the first filter is different from, e.g. less smooth than, a transfer function of the second filter.

27. A non-transitory digital storage medium having a computer program stored thereon to perform the method according to claim 21 when said computer program is run by a computer.
